(19) United States
(12) Patent Application Publication
(10) Pub. No.: US 2026/0149198 A1
(43) Pub. Date: May 28, 2026

(54) TERMINAL BLOCK MODULE, SYSTEM, AND METHOD

(71) Applicant: The Boeing Company, Arlington, VA (US)

(72) Inventor: Daniel M. Grippe, Summerville, SC (US)

(21) Appl. No.: 18/957,788

(22) Filed: Nov. 24, 2024

(51) Int. Cl. H01R 9/24; H01R 11/12; H01R 43/26

(52) U.S. Cl. CPC H01R 9/2416; H01R 9/2408; H01R 9/2475; H01R 11/12; H01R 43/26

(57) ABSTRACT

A terminal block module includes terminal fittings, first and second terminal blocks, and an electrically conductive element. The terminal fittings are electrically conductive and have a cylindrically shaped sleeve and a lip. The first and second terminal blocks are electrically non-conductive and have terminal recesses, each having a sleeve-receiving section and a lip-receiving section. Each cavity is configured to receive a terminal fitting in any rotational orientation, and prevent axial movement of the terminal fitting via the lip. The electrically conductive element is locatable at an interface of the mating surfaces of the block assembly and is configured to electrically couple at least two terminal fittings to each other and/or electrically couple at least one terminal fitting to an external electrical component that is separate from the block assembly.

### FIELD

The present disclosure relates generally to cable terminals and, more particularly, to a terminal block module for coupling an electrical cable to a terminal block.

### BACKGROUND

Electrical cables are widely used in many industries for transmitting electrical signals and electrical power. For example, power feeder cables are used in the marine, automotive, and aerospace industries for transmitting electrical power from a power source to a load. In some industries, power feeder cables are pre-assembled by a supplier and then shipped to a production facility for installation in a vehicle. During pre-assembly, conventional terminal fittings are installed on the ends of the power feeder cable. Each terminal fitting has a tongue for electrically connecting to a conventional terminal block during installation of the power feeder cable in the vehicle. A hole in the tongue is mounted on a stud of the terminal block, and a nut is threaded onto the stud to secure the tongue to the terminal block.

During pre-assembly of an electrical cable, the terminal fittings are rigidly crimped onto the cable ends at a fixed clocking orientation. When installing the electrical cable onto a vehicle, the clocking orientation of the terminal fitting may not align with the terminal block. Such misalignment can prevent the tongue of the terminal fitting from lying flat against the terminal block before the nut is secured onto the terminal stud. Although minor adjustments to the clocking orientation are possible, rotating the terminal fitting by more than a few degrees can introduce mechanical stress (i.e., preload) on the terminal block, the terminal fitting, and/or the electrical cable when the nut is tightened. A further drawback to conventional terminal fittings is that the connection of the terminal fitting to the stud is exposed to the environment, making it is susceptible to corrosion. Resolving these issues can require time-consuming and costly rework and/or replacement of the electrical cable and/or conventional terminal fitting.

As can be seen, there exists a need in the art for a system and method for attaching an electrical cable to a terminal block in any clocking orientation without introducing mechanical stress on the electrical cable or terminal block, while ensuring that the connection is sealed from exposure to the environment.

### SUMMARY

The above-noted needs associated with electrical terminals are specifically addressed and alleviated by the present disclosure which provides a terminal block module comprising one or more terminal fittings, a first terminal block, a second terminal block, and an electrically conductive element. The terminal fittings are formed of electrically conductive material and have a cylindrically shaped sleeve configured to receive a cable end of an electrical cable, and have a lip radially protruding from the sleeve. The first and second terminal blocks are formed of electrically non-conductive material and have a mating surface containing one or more terminal recesses, each having a sleeve-receiving section and a lip-receiving section configured complementary respectively to the sleeve and the lip and collectively forming one or more cavities configured to respectively contain the one or more terminal fittings when the first and second terminal blocks are assembled to form a block assembly. Each cavity is configured to receive a terminal fitting in any rotational orientation, and prevent axial movement of the terminal fitting via the lip. The electrically conductive element is locatable at an interface of the mating surfaces of the block assembly and is configured to electrically couple at least two terminal fittings to each other and/or electrically couple at least one terminal fitting to an external electrical component that is separate from the block assembly.

Also disclosed is a terminal block system comprising two or more terminal block modules located immediately adjacent to each other and electrically non-connected, and each terminal block module includes one or more terminal fittings, a first terminal block, a second terminal block, and an electrically conductive element. The terminal fittings are formed of electrically conductive material and have a cylindrically shaped sleeve configured to receive a cable end of an electrical cable, and have a lip radially protruding from the sleeve. The first and second terminal blocks are formed of electrically non-conductive material and have a mating surface containing one or more terminal recesses, each having a sleeve-receiving section and a lip-receiving section configured complementary respectively to the sleeve and the lip and collectively forming one or more cavities configured to respectively contain the one or more terminal fittings when the first and second terminal blocks are assembled to form a block assembly. Each cavity is configured to receive a terminal fitting in any rotational orientation, and prevent axial movement of the terminal fitting via the lip. The electrically conductive element is locatable at an interface of the mating surfaces of the block assembly and is configured to electrically couple at least two terminal fittings to each other and/or electrically couple at least one terminal fitting to an external electrical component that is separate from the block assembly.

Also disclosed is a method of assembling a terminal block module, comprising the step of providing one or more cable assemblies, each having a terminal fitting formed of electrically conductive material and having a cylindrically shaped sleeve mounted on a cable end of an electrical cable, and having a lip radially protruding from the sleeve. The method additionally includes providing a first terminal block and a second terminal block, each formed of electrically non-conductive material and having a mating surface containing one or more terminal recesses, each having a sleeve-receiving section and a lip-receiving section configured complementary respectively to the sleeve and the lip. The method also includes installing the one or more terminal fittings of the one or more cable assemblies in any rotational orientation respectively within the one or more terminal recesses of at least one of the first and second terminal blocks in a manner such that the sleeve and the lip are respectively received in the sleeve-receiving section and the lip-receiving section, and assembling the first and second terminal blocks to form a block assembly having one or more cavities collectively formed by the terminal recesses and respectively containing the one or more terminal fittings, and each cavity prevents axial movement of the terminal fitting via the lip. Furthermore, the method includes electrically coupling, using an electrically conductive element located at an interface of the mating surfaces of the block assembly, at least two terminal fittings to each other and/or at least one terminal fitting to an external electrical component that is separate from the block assembly.

The features, functions and advantages that have been discussed can be achieved independently in various embodiments of the present disclosure or may be combined in yet other embodiments, further details of which can be seen with reference to the following description and drawings below.

### BRIEF DESCRIPTION OF THE DRAWINGS

These and other features of the present disclosure will become more apparent upon reference to the drawings wherein like numbers refer to like parts throughout and wherein:

FIG. 1 is a perspective view of an example of a terminal block module in an assembled state and comprised of first and second terminal blocks, each containing terminal recesses for housing one or more terminal fittings, each of which is mounted on the cable end of an electrical cable;

FIG. 2 is a top-down exploded view of the terminal block module of FIG. 1 and illustrating a pair of terminal fittings that are receivable within cavities collectively defined by the terminal recesses formed in the first and second terminal blocks;

FIG. 3 is a bottom-up exploded view of the terminal block module of FIG. 2 with the mechanical fasteners omitted;

FIG. 4 shows an example of a cable assembly comprised of a terminal fitting mounted on an electrical cable;

FIG. 5 is an exploded view of the cable assembly of FIG. 4;

FIG. 6 is a perspective view of an example of a terminal block configured to receive a cable end of an electrical cable;

FIG. 7 is a sectional view of the cable assembly of FIG. 4;

FIG. 8 is a top-down perspective view of an example of the first terminal block having a mating surface containing an electrically conductive layer of material configured to electrically couple two terminal fittings receivable within the terminal recesses of the first terminal block;

FIG. 9 is a top view of the terminal block module of FIG. 1;

FIG. 10 is a sectional view of the terminal block module taken along line 10-10 of FIG. 9, and illustrating a terminal fitting contained within a cavity collectively formed by the terminal recesses of the first and second terminal blocks when mated to each other;

FIG. 11 is an exploded perspective view of the first terminal block and an electrically conductive plate configured to electrically couple the two terminal fittings when contained within the cavities collectively formed between the first and second terminal blocks;

FIG. 12 is an exploded perspective view of an example of a terminal block module showing the electrically conductive plate nested within the plate recess of the first terminal block;

FIG. 13 is a sectional view of the terminal block module of FIG. 12 showing the electrically conductive plate extending between the terminal fittings;

FIG. 14 is an example of a terminal block module in which each of the cable assemblies has a cable seal configured to limit exposure of the interior of the first and second terminal block to the external environment;

FIG. 15 is a perspective view of an example of a cable assembly having a cable seal;

FIG. 16 is a sectional view of the terminal block module taken along line 16-16 of FIG. 14;

FIG. 17 is a magnified view of the portion of the terminal block module identified by reference numeral 17 of FIG. 16 and illustrating an example of the cable seal having an annular shoulder seated within an annular groove formed in the first and second terminal blocks;

FIG. 18 is a perspective view of an example of the first terminal block containing a block seal extending along a perimeter of the interface of the first terminal block and configured to limit exposure of the interface to the external environment;

FIG. 19 is a sectional view taken along line 19-19 of FIG. 18, and illustrating an example of the block seal configured as an elastomeric seal;

FIG. 20 is a magnified view of the portion of the terminal block module identified by reference numeral 20 of FIG. 19, and illustrating an example of the elastomeric seal nested within a perimeter groove formed in at least one of the first and second terminal blocks;

FIG. 21 is a magnified view of an example of the block seal configured as a sealant bead applied to the mating surface as wet sealant prior to assembling the first and second blocks to each other;

FIG. 22 is an example of a terminal block module configured to contain a single terminal fitting, and further including a lug fitting having a lug tongue for electrically coupling the electrical cable to a conventional terminal block;

FIG. 23 is an exploded view of the cable assembly and first terminal block of the terminal block module of FIG. 22 illustrating the lug fitting having a lug body portion configured to electrically contact a terminal fitting when placed in the terminal recess of the first terminal block;

FIG. 24 is a sectional view taken along line 24-24 of FIG. 23 and illustrating the lug fitting integrated into the first terminal block and further illustrating the lug tongue protruding from the first terminal block;

FIG. 25 shows the terminal block module of FIG. 22 secured to a terminal stud of a conventional terminal block;

FIG. 26 shows an example of a terminal block module configured to contain a pair of terminal fittings in end-to-end arrangement;

FIG. 27 is an exploded view of the terminal block module of FIG. 26 showing the end-to-end terminal fittings;

FIG. 28 shows an example of a terminal block module configured to contain a pair of terminal fittings with each pair in end-to-end arrangement;

FIG. 29 is an exploded view of the terminal block module of FIG. 28 and illustrating an electrically conductive layer of material deposited onto the mating surface of the first terminal block and configured to separately electrically couple the end-to-end terminal fittings located on each side of the terminal block module;

FIG. 30 shows an example of a terminal block system containing two terminal block modules stacked on top of each other;

FIG. 31 is an exploded view of the terminal block system of FIG. 30;

FIG. 32 shows an example of a terminal block system containing two terminal block modules positioned side-by-side;

FIG. 33 is an exploded view of the terminal block system of FIG. 32;

FIG. 34 is a flowchart of operations included in a method of assembling a terminal block module.

### DETAILED DESCRIPTION

Disclosed examples or versions will now be described more fully hereinafter with reference to the accompanying drawings, in which some, but not all of the disclosed examples or versions are shown. Indeed, several different examples or versions may be provided, and should not be construed as limited to the examples or versions set forth herein. Rather, these examples or versions are provided so that this disclosure will be thorough and fully convey the scope of the disclosure to those skilled in the art.

This specification includes references to “some examples,” “one example,” or “an example.” Instances of the phrases “some examples,” “one example” or “an example” do not necessarily refer to the same example. Particular features, structures, or characteristics may be combined in any suitable manner consistent with this disclosure.

As used herein, “comprising” is an open-ended term, and as used in the claims, this term does not foreclose additional structures or steps.

As used herein, “configured to” means various parts or components may be described or claimed as “configured to” perform a task or tasks. In such contexts, “configured to” is used to connote structure by indicating that the parts or components include structure that performs those task or tasks during operation. As such, the parts or components can be said to be configured to perform the task even when the specified part or component is not currently operational (e.g., is not on).

As used herein, an element or step recited in the singular and preceded by the word “a” or “an” should be understood as not necessarily excluding the plural of the elements or steps.

As used herein, the phrase “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

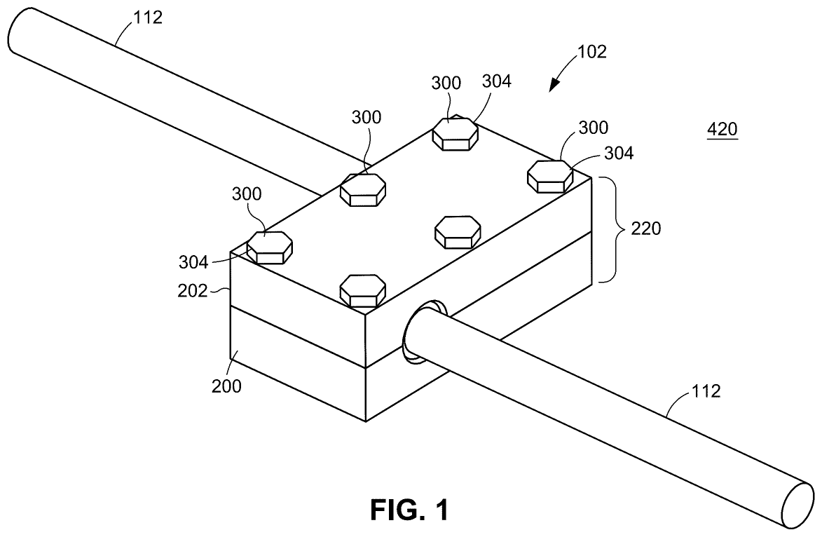

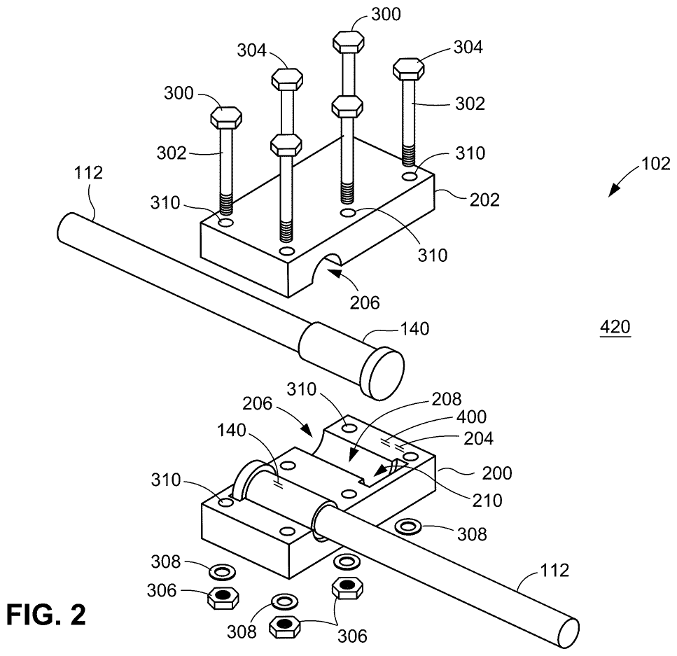

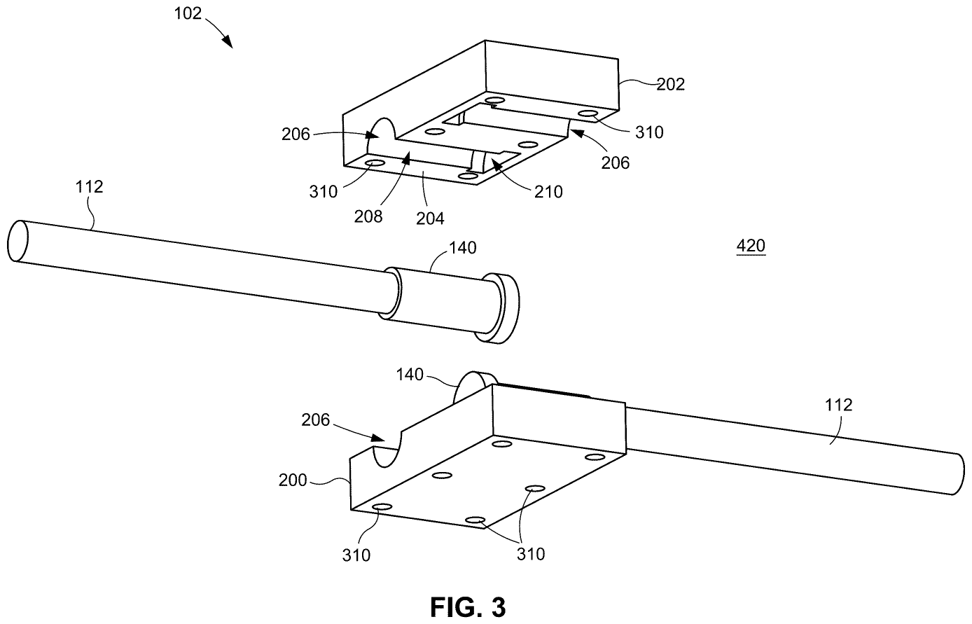

Referring FIGS. 1-3, shown is an example of a terminal block module 102 for electrically connecting electrical cables 112. The terminal block module 102 includes one or more terminal fittings 140, a first terminal block 200, a second terminal block 202, and an electrically conductive element 400. FIG. 1 shows an example of the terminal block module 102 in an assembled state in which the first and second terminal blocks 200, 202 are fastened together with mechanical fasteners 300 to form a block assembly 220 with the terminal fittings 140 contained within. FIGS. 2-3 show the terminal block module 102 in an exploded state. In FIG. 3, the mechanical fasteners 300 of FIGS. 1-2 are omitted. As described in greater detail below, the terminal block module 102 in the assembled state advantageously locks the terminal fittings 140 inside the block assembly 220 while electrically coupling the terminal fittings 140 to each other and optionally sealing the terminal fittings 140 from exposure to the external environment 420. Notably, the terminal fittings 140 have a cylindrical shape which allows for positioning the terminal fittings 140 in any clocking orientation within the block assembly 220, which avoids introducing mechanical stress on the electrical cable 112 or the first and second terminal blocks 200, 202.

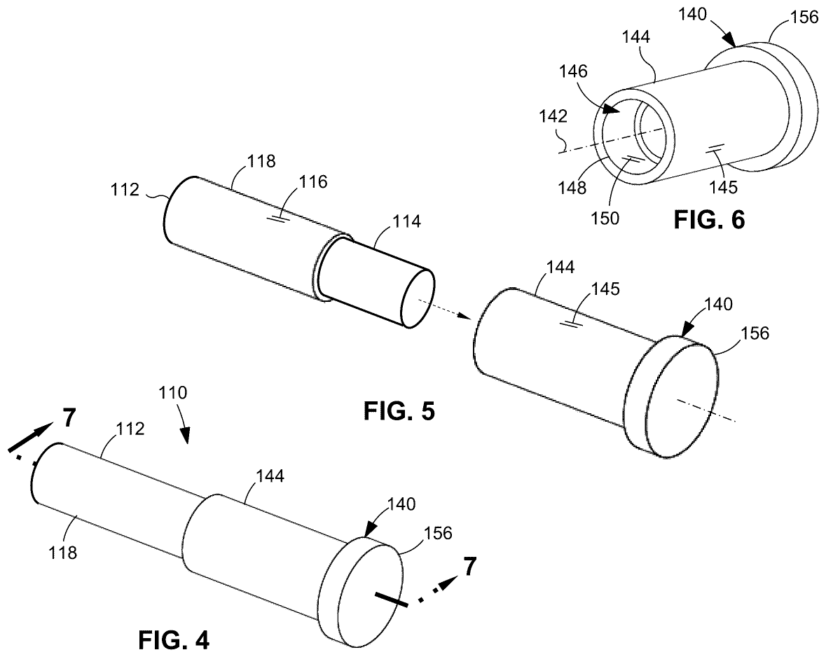

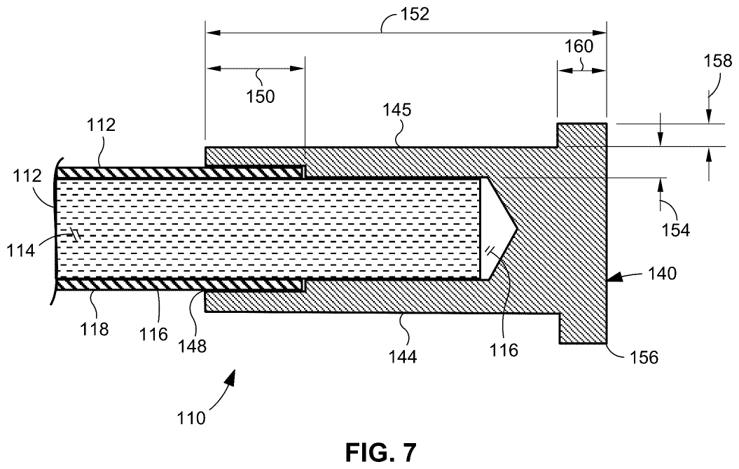

Referring to FIGS. 2-7, each terminal fitting 140 is formed of electrically conductive material and is configured to receive a cable end 118 of an electrical cable 112, as shown in FIGS. 4-6. The combination of a terminal fitting 140 mounted on an electrical cable 112 forms a cable assembly 110. The electrically conductive material of the terminal fitting 140 can include metallic material such as copper, aluminum, steel, or any other metallic material or combination thereof. Alternatively or additionally, the terminal fitting 140 can be formed of non-metallic material such as electrically conductive polymeric material and/or electrically conductive ceramic material.

Referring to FIGS. 4-6, each terminal fitting 140 is comprised of a sleeve 144 and a lip 156, which is integrated with the sleeve 144. The sleeve 144 has a sleeve outer surface 145, a central axis 142, a sleeve interior 146, and a sleeve opening 148. The sleeve outer surface 145 is cylindrical to allow for clocking the terminal fitting 140 at any orientation relative to the first and second terminal blocks 200, 202. The sleeve interior 146 is sized and configured to receive the cable end 118 of an electrical cable 112. In the example shown, the sleeve interior 146 is cylindrically shaped, although in other examples not shown, the sleeve interior 146 can have a non-cylindrical shape. In the example shown, the cable has a conductive core 114 covered by a layer of cable insulation 116 formed of electrically non-conductive material such as plastic or rubber. The sleeve opening 148 in the terminal fitting 140 has an insulation grip portion 150 which may be described as a counterbore formed in the sleeve interior 146 for receiving a lengthwise section of the cable insulation 116 covering the conductive core 114. Although the present example shows the sleeve opening 148 on a single end of the terminal fitting 140 and closed on the opposite end, in other examples not shown, the sleeve 144 can be open on both ends of the terminal fitting 140.

The terminal fitting 140 can be secured onto the electrical cable 112 via swaging, soldering, or any other suitable means. For example, the terminal fitting 140 can be secured onto the conductive core 114 of an electrical cable 112 using a crimping tool to locally deform the sleeve 144 in a manner establishing positive mechanical connection and electrical connection between the terminal fitting 140 and the conductive core 114. In the present disclosure, the conductive core 114 of the electrical cable 112 can be a single, monolithic length of material (e.g., copper, aluminum, steel, etc.). In other examples, the conductive core 114 can be comprised of braided wire strands (not shown).

Referring to FIGS. 4-7, the terminal fittings 140 can be configured to receive electrical cables 112 of any one of a variety of different sizes, diameters, or gauges. For example, for sizes defined in terms of American Wire Gauge (AWG), the electrical cable 112 can range from 8 AWG (e.g., diameter of approx. 3.26 mm; 0.128 inch) to 4/0 AWG (e.g., diameter of approx. 11.68 mm; 0.460 inch) or larger. In the example shown, the terminal block module 102 is sized and configured complementary to an electrical cable 112 in which the conductive core 114 has a diameter of 0.44 inch, and the cable insulation 116 has a diameter of 0.54 inch. The sleeve 144 of the terminal fitting 140 has a wall thickness 154 of 0.21 inch, an outer diameter of 0.68 inch, and a sleeve length 152 of 1.5 inch. However, the terminal fitting 140 can be provided in any one of a variety of sizes. For example, the dimensions (e.g., sleeve length 152, wall thickness 154, etc.) of a terminal fitting 140 can be based on the mechanical loads on the terminal block module 102 and/or on the electrical conductivity requirements of the terminal fitting 140. In one example, the sleeve 144 can have a sleeve length 152 in the range of 1-10 times (or more) the diameter of the conductive core 114 of the electrical cable 112, and a wall thickness 154 in the range of 0.10-1.0 or more times the diameter of the conductive core 114.

Referring still to FIGS. 4-7, the lip 156 may be described as a radially outwardly projecting edge that extends circumferentially around the sleeve 144. As described in greater detail below, the lip 156 prevents axial movement of a terminal fitting 140 when captured between the first and second terminal blocks 200, 202 when assembled to each other. The lip 156 has a lip length 160 and a lip height 158. The lip height 158 is the amount by which the lip 156 protrudes above the sleeve outer surface 145. In the example shown in which the electrical cable 112 has a diameter of 0.44 inch, the lip 156 has a lip height 158 of 0.21 inch, an outer diameter of 0.90 inch, and a lip length 160 of 0.21 inch. However, the dimensions of the lip 156 can be provided in any one of a variety of sizes based on the anticipated mechanical loads on the electrical cable 112, such as the maximum anticipated axial force to which the electrical cable 112 will be subjected during its service life.

In the example shown, the lip 156 is located on an end of the sleeve 144 opposite the sleeve opening 148. However, in other examples not shown, the lip 156 can be located at any position along the length of the terminal fitting 140. For example, the lip 156 can be located at the approximate midpoint of the sleeve length 152. In still other examples not shown, the lip 156 can be located on the end of the sleeve 144 where the electrical cable 112 enters the sleeve interior 146. In still further examples not shown, the lip 156 can be provided as one or more circumferentially spaced bosses that protrude radially beyond the sleeve outer surface 145, and are configured to prevent axial movement of the terminal fitting 140 when captured between the first and second terminal blocks 200, 202. In this regard, the lip 156 is not limited to the radially outwardly projecting edge shown in the figures.

Referring back to FIGS. 1-2, as mentioned above, the terminal block module 102 includes first and second terminal blocks 200, 202, which are configured to be assembled to each other to form a block assembly 220 (FIG. 1) containing one or more terminal fittings 140. In this regard, the terminal block module 102 includes one or more mechanical fasteners 300 configured to fasten together the first and second terminal blocks 200, 202. The mechanical fasteners 300 can be threaded elements 302 such as bolts 304 (e.g., 0.25 inch diameter) inserted into fastener holes 310 formed in the first and/or second terminal blocks 200, 202, and secured with washers 308 and nuts 306. Alternatively or additionally, in an example not shown, the mechanical fasteners 300 can be provided as threaded studs protruding from the mating surface 204 of the first terminal block 200, and which are extendable through fastener holes 310 formed in the second terminal block 202 and secured with nuts 306 and washers 308.

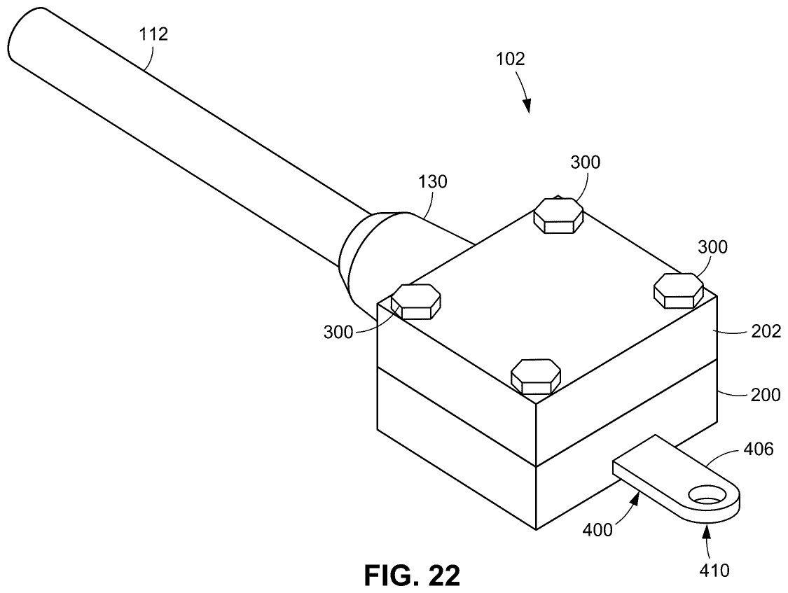

Regardless of the type of mechanical fastener 300, in the examples shown, the terminal block module 102 includes a mechanical fastener 300 at each corner of the block assembly 220. For certain configurations of the terminal block module 102 (e.g., FIGS. 1-2 and 26-33), a mechanical fastener 300 is also located midway along at least two sides of the block assembly 220. However, smaller configurations of the terminal block module 102, such as the one shown in FIGS. 22-25, can be limited to a mechanical fastener 300 at each corner of the block assembly 220. In still other examples not shown, a terminal block module 102 can be even further limited in the number of mechanical fasteners 300 required for securing together the first and second terminal blocks 200, 202. For example, a terminal block module 102 (not shown) can be provided with one mechanical fastener 300 on each of two opposing sides of the terminal block module 102. In still further examples of the terminal block module 102 not shown, the first and second terminal blocks 200, 202 can be adhesively bonded to each other using adhesive (e.g., an electrically conductive adhesive) at the interface 222, which may optionally serve as the electrically conductive element 400 for electrically coupling the terminal fittings 140.

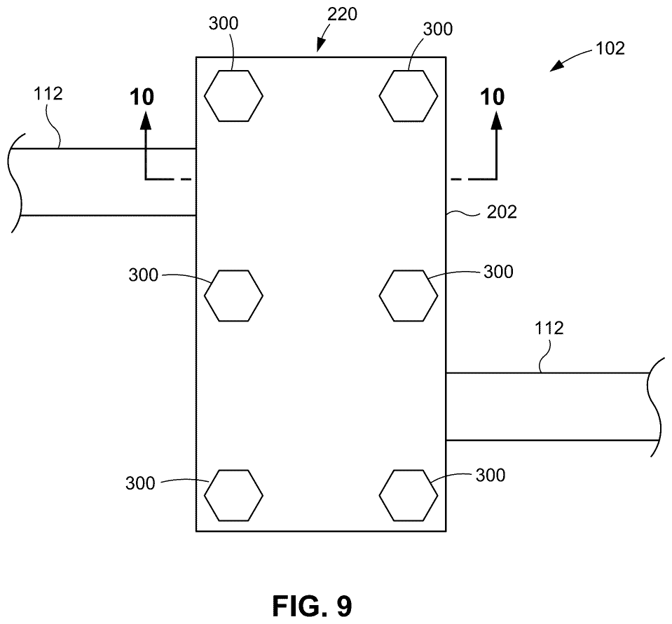

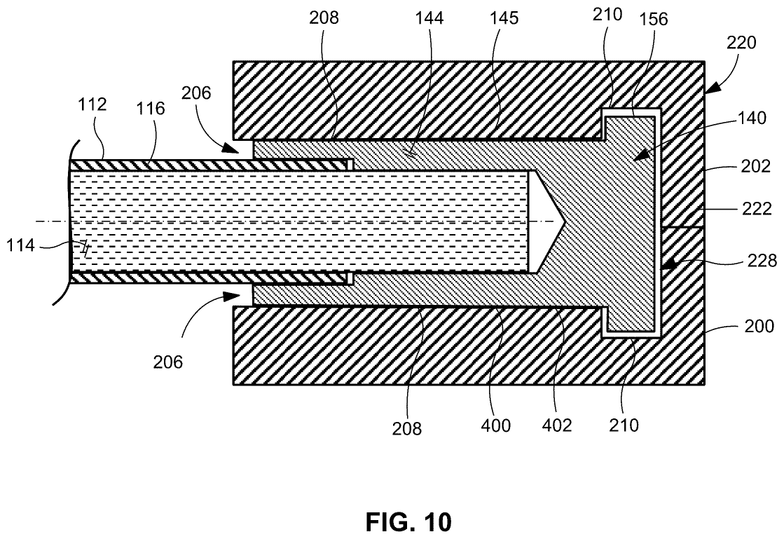

Each of the first and second terminal blocks 200, 202 is formed of electrically non-conductive material. For example, the first and second terminal blocks 200, 202 can be formed of electrically non-conductive plastic, polymeric material, composite material (e.g., carbon-fiber), or other non-electrically conductive materials including, but not limited to, ceramic and/or nylon. In the example shown, the first and second terminal blocks 200, 202 each have a rectangularly shaped profile when viewed from a top-down perspective (FIG. 9) and when viewed from a side-view perspective (FIG. 10).

For the above-described example in which the terminal block module 102 and terminal fitting(s) 140 are sized complementary to an electrical cable 112 having a diameter of 0.44 inch, the first and second terminal blocks 200, 202 each have a length of 3.8 inches, a width of 2.0 inches, and a height of 0.7 inch. However, the first and second terminal blocks 200, 202 can be provided in any one of a variety of different sizes, shapes, and configurations, and are not limited to a rectangular profile shape. The sizes, shapes, and/or configurations of the first and second terminal blocks 200, 202 may be based on mechanical loads to which the terminal block module 102 may be subjected. In the example of FIGS. 1-7, the first terminal block 200 is identical in size, shape, and configuration to the second terminal block 202, which advantageously simplifies manufacturing and reduces inventory costs. However the first terminal block 200 can be provided in a size, shape, and/or configuration that is different than the second terminal block 202. Although not shown, at least one of the first and second terminal blocks 200, 202 can include mounting tabs for fixedly securing the terminal block module 102 to a structure.

Referring to FIGS. 2-3 and 8-10, the first and second terminal blocks 200, 202 each have a mating surface 204 containing one or more terminal recesses 206. The mating surfaces 204 of the first and second terminal blocks 200, 202 face each other when the first and second terminal blocks 200, 202 are assembled. In the example shown, the mating surface 204 of each of the first and second terminal blocks 200, 202 is planar. However, in other examples not shown, each mating surface 204 can be slightly non-planar (not shown) and/or can have features (not shown) such as depressions and/or holes, such as to reduce the weight of the first and second terminal blocks 200, 202.

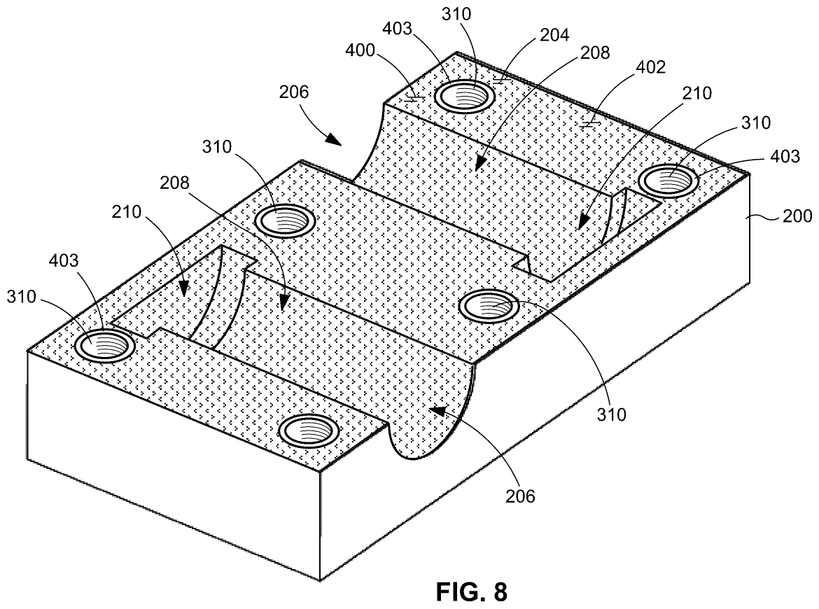

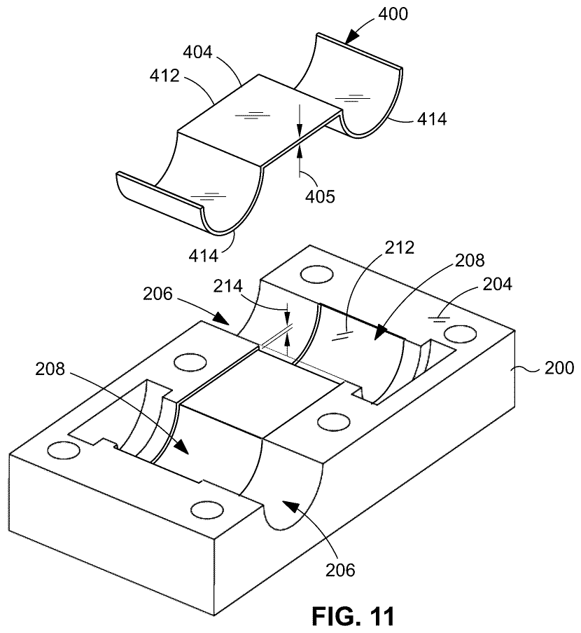

In FIGS. 2-10, the mating surface 204 of the first and second terminal blocks 200, 202 each contain one or more terminal recesses 206, which can be described as being form fitted to the terminal fittings 140. For example, each terminal recess 206 has a sleeve-receiving section 208 and a lip-receiving section 210 configured complementary respectively to the sleeve 144 and the lip 156 of a terminal fitting 140. The sleeve-receiving section 208 has a semi-cylindrical shape that is preferably similar in size or slightly larger (e.g., in diameter) than the cylindrically-shaped sleeve outer surface 145 of the terminal fitting 140 to allow for easy (i.e., non-binding) installation and removal of the terminal fitting 140 from the sleeve-receiving section 208 of the first and second terminal blocks 200, 202. In addition, the sizing of the sleeve-receiving section 208 relative to the sleeve outer surface 145 of the terminal fitting 140 ensures direct, physical contact between the sleeve 144 and an electrically conductive element 400 (e.g., FIGS. 8, 11) that extends into the sleeve-receiving sections 208 of the first and/or second terminal blocks 200, 202, as described in greater detail below.

In FIGS. 2-6, the lip-receiving section 210 is shown having a semi-cylindrical shape, which may be complementary to the cylindrical shape of the lip 156. However, in other examples not shown, the lip-receiving section 210 can have a non-semi-cylindrical shape. Alternatively or additionally, the lip-receiving section 210 may be larger than the lip 156 such that an annular gap exists between the radially outer surface of the lip 156 and the lip-receiving section 210 of the first and second terminal blocks 200, 202. In such an arrangement, electrical continuity between the terminal fitting 140 and the electrically conductive element 400 is provided by the direct, physical contact between the sleeve outer surface 145 and the portion of the electrically conductive element 400 inside the sleeve-receiving section 208 of the first and/or second terminal blocks 200, 202.

The first and second terminal blocks 200, 202 are configured such that when assembled to each other to form a block assembly 220, each terminal recess 206 in the first terminal block 200 is aligned with a terminal recess 206 in the second terminal block 202 in a manner collectively forming a cavity 228 (FIG. 10). Each cavity 228 is configured to enclose the sleeve 144 of a terminal fitting 140 within the sleeve-receiving sections 208 of the first and second terminal blocks 200, 202, and enclose the lip 156 of the terminal fitting 140 within the lip-receiving sections 210 of the first and second terminal blocks 200, 202. In the example shown, the cavities 228 are identical in size and shape for receiving terminal fittings 140 of a common size and shape. However in other examples not shown, the terminal block module 102 can be configured such that the cavities 228 that are collectively formed when the first and second terminal blocks 200, 202 are assembled are different in size (e.g., diameter) and/or shape for respectively receiving terminal fittings 140 of different sizes and/or shapes.

Regardless of size and shape, each cavity 228 is configured to receive a terminal fitting 140 in any rotational orientation due to the cylindrical shape of the sleeve outer surface 145 and the semi-cylindrical shape of the sleeve-receiving sections 208. In this manner, each cavity 228 allows for unrestricted rotational positioning of a terminal fitting 140 about its central axis 142. The lip 156 of each terminal fitting 140 is received within the lip 156 receiving sections of the first and second terminal blocks 200, 202 in a manner preventing prevent axial movement of the terminal fitting 140. More specifically, the larger size of the lip 156 of each terminal fitting 140 relative to the sleeve-receiving sections 208 of the first and second terminal blocks 200, 202 prevents axial movement of each terminal fitting 140 with the one or more cavities 228 of the first and second terminal blocks 200, 202.

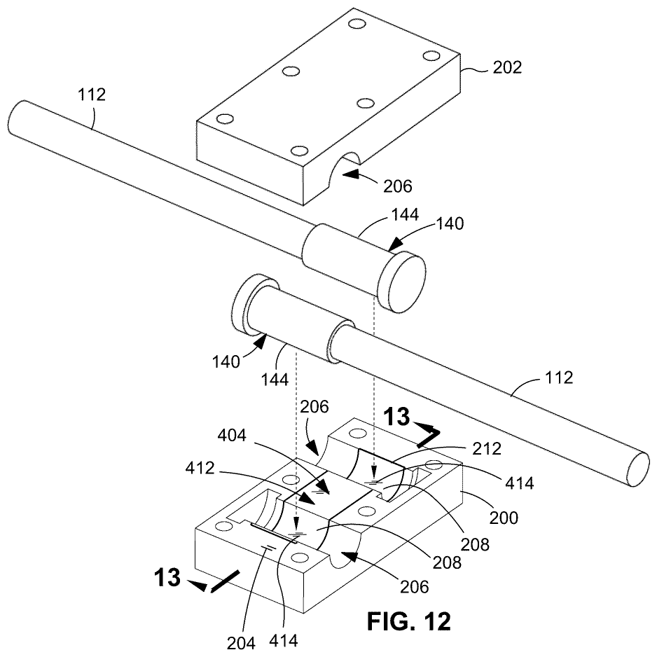

Referring to FIGS. 8-13, the terminal block module 102 includes the above-mentioned electrically conductive element 400 which is locatable at an interface 222 between the mating surfaces 204 of the first and second terminal blocks 200, 202 when assembled to each other. The electrically conductive element 400 is configured to electrically couple at least two terminal fittings 140 to each other as shown in FIGS. 8-13, 27, 29, and 33 and described below. In another configuration of the terminal block module 102 shown in FIGS. 22-25, the electrically conductive element 400 is configured to electrically couple at least one terminal fitting 140 to an external electrical component 450 that is separate from and located outside of the block assembly 220, as described below.

FIG. 8-10 show an example in which the electrically conductive element 400 is configured as an electrically conductive layer 402 of material deposited onto the mating surface 204 and the one or more sleeve-receiving sections 208 of at least one of the first and second terminal blocks 200, 202. For example, FIG. 8 shows an example of an electrically conductive layer 402 of material deposited onto the mating surface 204 of the first terminal block 200 of a terminal block module 102. FIG. 10 is a sectional view of the terminal block module 102 showing a terminal fitting 140 contained within a cavity 228 collectively formed by the terminal recesses 206 of the first and second terminal blocks 200, 202, and illustrating an electrically conductive layer 402 on the sleeve-receiving sections 208 of the first and second terminal blocks 200, 202. The electrically conductive layer 402 of material in FIGS. 8 and 10 is configured to electrically couple two terminal fittings 140 (e.g., FIGS. 2-3) that are receivable respectively within the two terminal recesses 206 of the first terminal block 200. Although FIG. 10 shows an electrically conductive layer 402 of material deposited onto the mating surfaces 204 of both the first and second terminal blocks 200, 202, in other examples not shown, the electrically conductive layer 402 of material can be omitted from one of the first and second terminal blocks 200, 202. For example, the electrically conductive layer 402 of material can be limited to the mating surface 204 of only the first terminal block 200, and can be omitted from the mating surface 204 of the second terminal block 202, or vice versa.

In the example of FIG. 8, the electrically conductive layer 402 is applied to the entirety of the mating surface 204 and the entirety of both of the terminal cavities 228, including the sleeve-receiving sections 208 and the lip-receiving sections 210. To prevent contact between the mechanical fasteners 300 and the electrically conductive layer 402, the electrically conductive layer 402 can be omitted from an annularly-shaped area 403 surrounding each fastener hole 310 as a means to prevent the mechanical fasteners 300 (FIGS. 1-2) from conducting electricity carried by the electrically conductive layer 402. Alternatively or additionally, an electrically non-conductive ring (not shown) can be installed around each fastener hole 310 at the interface 222 to prevent contact between the mechanical fasteners 300 and the electrically conductive layer 402. Each electrically non-conductive ring can be received within a shallow counterbore (not shown) formed in the mating surface 204 at each fastener hole 310. The electrically non-conductive ring can optionally be formed of elastomeric material (e.g., rubber) to allow the ring to function as a bolt seal to prevent intrusion of moisture and/or debris from the external environment 420 via the fastener holes 310.

In a still further example not shown, a plastic sleeve (not shown) can be installed over each mechanical fastener 300 to electrically insulate it from the electrically conductive layer 402. However, in other examples not shown, the electrically conductive layer 402 can be limited to at least a portion of each of the sleeve-receiving sections 208 and to a narrow band or area of the mating surface 204 extending between the sleeve-receiving sections 208. In such an example, the electrically conductive layer 402 can be omitted from all other portions of the mating surface 204 including the lip-receiving sections 210 and the areas of the mating surface 204 near the fastener holes 310.

The electrically conductive layer 402 can be a relatively thin layer of metallic material such as copper, aluminum, steel and/or other metallic material. Alternatively or additionally, the electrically conductive layer 402 can be a relatively thin layer of non-metallic material such as electrically conductive polymeric material and/or electrically conductive ceramic material. The thickness of the electrically conductive layer 402 can range from several microns up to one or more thousands of an inch (e.g., 0.001 to 0.010 inch or more). The material composition and/or the thickness of the electrically conductive layer 402 can be selected based on the heat load and/or the electrical current (i.e., electrical power) to be transferred between the terminal fittings 140. The layer of material can be deposited onto the mating surface 204 and at least a portion of the sleeve-receiving section 208 of each of the one or more terminal recesses 206 of the first and/or second terminal blocks 200, 202 using any one of a variety of deposition techniques including, but not limited to, physical vapor deposition, chemical vapor deposition, and/or thermal spraying.

FIGS. 11-13 show an example of the first terminal block 200 of a terminal block module 102 in which the electrically conductive element 400 is configured as an electrically conductive plate 404. The electrically conductive plate 404 is configured to be positioned between the mating surfaces 204 of the first and the second terminal blocks, and to maintain contact with the one or more terminal fittings 140 when captured within the block assembly 220. The an electrically conductive plate 404 can be formed of metallic material including, but not limited to, copper, aluminum, steel, and/or non-metallic material including, but not limited to, electrically conductive polymeric material and/or electrically conductive ceramic material. In this regard, the electrically conductive plate 404 can be formed of any material capable of maintaining its structural integrity under heat and conductivity loads imposed on the terminal block module 102.

In the example of FIGS. 11-13, the electrically conductive plate 404 is limited to extending between the terminal recess 206, and does not extend to the outer perimeter of the first terminal block 200 and/or second terminal block 202. However, in other examples not shown, the electrically conductive plate 404 may extend to one or more of the perimeter edges of the mating surfaces 204 of the first and/or second terminal blocks 200, 202 when viewed from a top-down perspective. The electrically conductive plate 404 includes portions that are contoured complementary to the shape of the terminal fittings 140 as well as complementary to the shape of the mating surface 204 (e.g., flat or planar) of the first or second terminal block 200, 202. For example, as shown in FIG. 11, each of the opposing ends of the electrically conductive plate 404 has a semi-cylindrical cross section that is sized and shaped complementary to the cylindrical shape of the sleeve-receiving sections 208 of the terminal recesses 206. The planar portion 412 of the electrically conductive plate 404 between its semi-cylindrical ends is flat to match the flat =shape of the mating surfaces 204.

As shown in FIGS. 11-13, the first terminal block 200 and/or the second terminal block 202 can include a plate recess 212 formed within the mating surface 204 and within at least a portion of the sleeve-receiving sections 208 of each of the one or more the terminal recesses 206 of at least one of the first and second terminal blocks 200, 202. The plate recess 212 in the first and/or second terminal block 200, 202 is sized and shaped complementary to the electrically conductive plate 404 in a manner allowing the electrically conductive plate 404 to nest within the plate recess 212. In this regard, the electrically conductive plate 404 and the plate recess 212 respectively have a plate thickness 405 and a recess depth 214 configured such that the electrically conductive plate 404 is maintained in continuous contact with the one or more terminal fittings 140 when captured within the terminal block module 102. In one example, the electrically conductive plate 404 can have a plate thickness 405 in the range of 0.010 to 0.100 inch. However, plate thicknesses 405 of less than 0.010 inch or greater than 0.100 inch are possible.

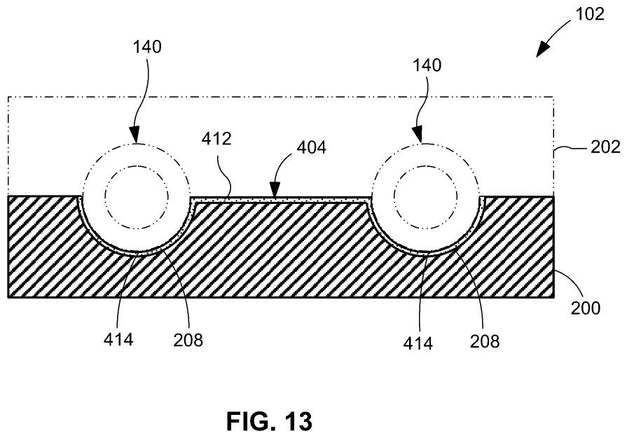

The plate thickness 405 and/or the recess depth 214 are sized such that the electrically conductive plate 404 protrudes at least several thousands of an inch (e.g., 0.002-0.010 inch or more) above the surface of each sleeve-receiving section 208, to thereby ensure direct physical contact between the electrically conductive plate 404 and the one or more terminal fittings 140 respectively captured within the one or more cavities 228 of the terminal block module 102. Although FIG. 13 shows an electrically conductive plate 404 nested only within the plate recess 212 in the first terminal block 200, in other examples not shown, a terminal block module 102 can have two electrically conductive plates 404 for redundancy, including a first electrically conductive plate nested within a plate recess 212 in the first terminal block 200, and a second electrically conductive plate nested within a plate recess 212 in the second terminal block 202.

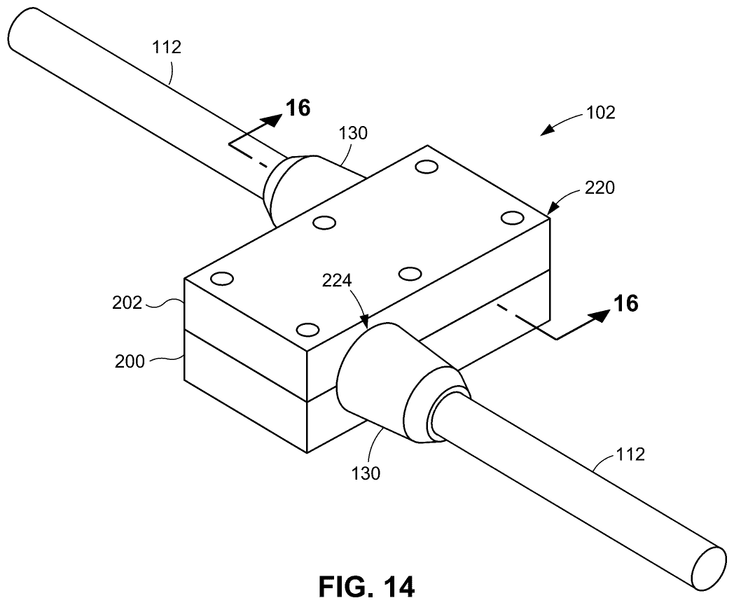

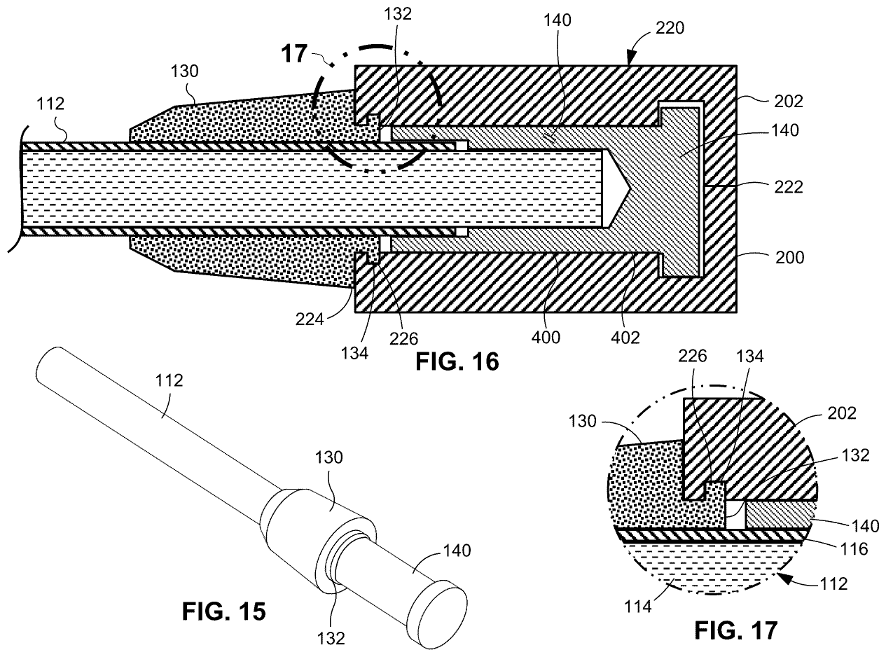

Referring to FIGS. 14-17, shown is an example of a terminal block module 102 having a cable seal 130 at each location where an electrical cable 112 exits the block assembly 220. Each cable seal 130 is configured to surround the electrical cable 112 at its cable exit 224. The cable seal 130 is configured to limit exposure of the interface 222 to an external environment 420 of the block assembly 220. For example, the cable seal 130 is configured to reduce or prevent the intrusion of moisture, dirt, and/or other contaminants into the cable exit 224, which could potentially migrate to the terminal fittings 140 and, over time, affect their electrical connectivity with the electrically conductive element 400 (e.g., electrically conductive layer 402, electrically conductive plate 404). The cable seal 130 can be formed of an elastomeric material such as rubber, silicon, Teflon™, or any one of a variety of other materials capable of sealing the cable exits 224.

Referring to the example of FIGS. 16-17, each cable seal 130 can be configured to engage with the block assembly 220 in a manner retaining the cable seal 130 in position against the block assembly 220. For example, the cable seal 130 can have a reduced-diameter portion 132 configured to protrude partially into the cable exit 224 and seal against the block assembly 220. The reduced-diameter portion 132 can be provided with an annular shoulder 134 configured to be received within an annular groove 226 formed in the block assembly 220 at the cable exit 224. The engagement of the annular shoulder 134 with the annular groove 226 locks the cable seal 130 to the block assembly 220 and further reduces the risk of exposure of the terminal fittings 140 inside the block assembly 220 to the external environment 420.

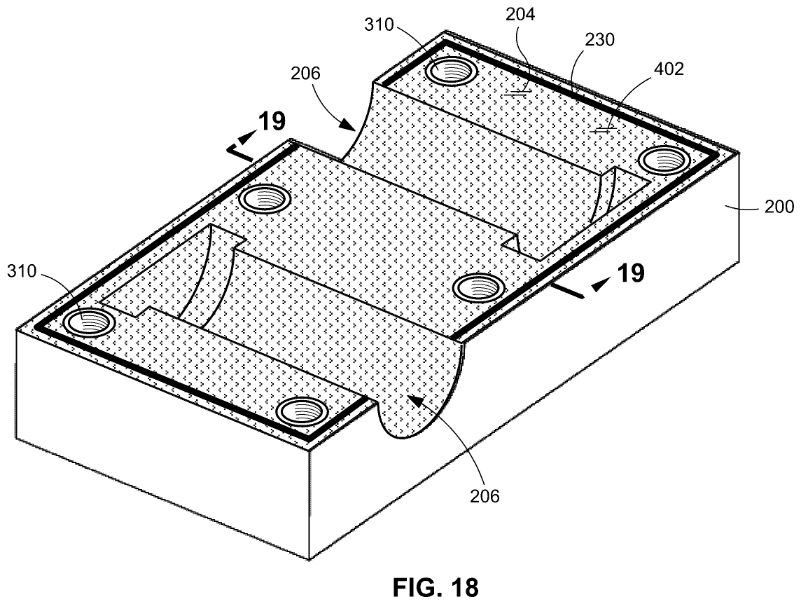

Referring to FIGS. 18-21, shown is an example of a first terminal block 200 having a block seal 230 positioned on its mating surface 204. In FIG. 18, the block seal 230 extends along the perimeter of the mating surface 204 and is configured to seal the interface 222 of the block assembly 220 when the first and second terminal blocks 200, 202 are assembled to each other, thereby compressing the block seal 230 between the mating surfaces 204 of the first and second terminal blocks 200, 202. The block seal 230 is configured to limit exposure of the interface 222 (FIG. 16) to the external environment 420 of the block assembly 220. In this regard, the block seal 230 is configured to reduce or prevent the intrusion of moisture, dirt, and/or contaminants into the interface 222, similar to the function of the above-described cable seal 130. However, the block seal 230 can be in addition to or an alternative to the cable seals 130.

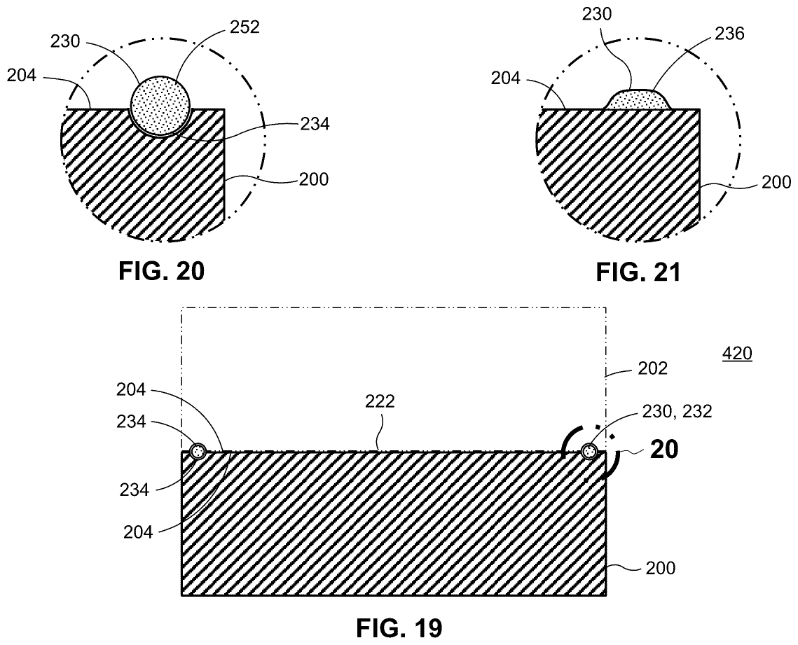

Referring to FIGS. 19-20, the block seal 230 can be formed of an elastomeric material such as rubber, silicon, Teflon™, or any one of a variety of other materials capable of sealing the interface 222. In the example shown, the block seal 230 has a circular cross section in the uncompressed state, and can have a diameter in the range of 0.10-0.25 inch or more. The mating surface 204 of the first and/or second terminal blocks 200, 202 can optionally include a perimeter groove 234 sized and configured to receive the block seal 230. The block seal 230 can be configured to be easily replaceable by simply lifting the block seal 230 from the first or second terminal block 200, 202, and installing a new block seal 230 in its place.

Referring to FIG. 21, shown is an example of a block seal 230 applied as a sealant bead 236 of wet sealant (i.e., in a pre-cured state) to the mating surface 204 of the first terminal block 200 and/or the second terminal block 202. The sealant bead 236 can be applied to the mating surface(s) 204 after installation of the terminal fittings 140 (attached to electrical cables 112) into the one or more terminal recesses 206 of the first or second terminal block 200, 202. After application of the sealant bead 236, the first and second terminal blocks 200, 202 are assembled to each other, and the sealant bead 236 is allowed to cure over time to thereby prevent exposure of the interface 222 (FIG. 19) to the external environment 420.

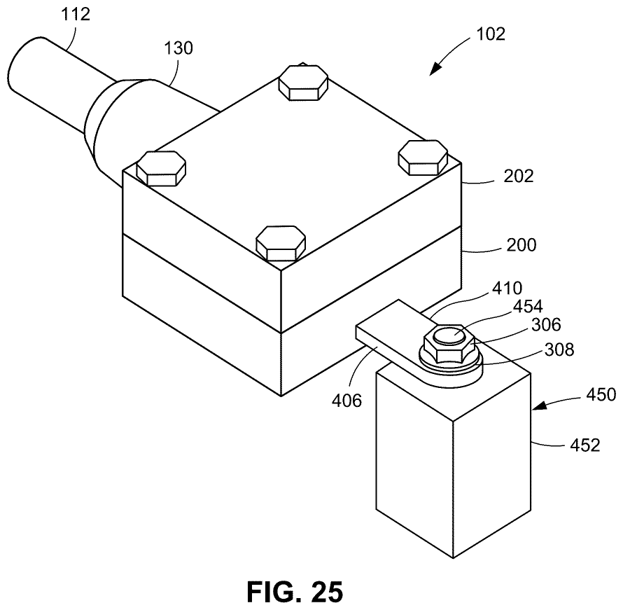

Referring to FIGS. 22-25, shown is an example of a terminal block module 102 in which the electrically conductive element 400 is a lug fitting 406 configured to electrically couple at least one terminal fitting 140 to an external electrical component 450 (FIG. 25). In the example shown, the terminal block module 102 is configured to contain a single terminal fitting 140. However, in other examples not shown, the terminal block module 102 can be configured to contain two or more terminal fittings 140. The lug fitting 406 is formed of electrically conductive material such as metallic material (e.g., copper, aluminum, steel, etc.) or electrically conductive non-metallic material. The lug fitting 406 is configured to be at least partially embedded within one of the first and second terminal blocks 200, 202. The lug fitting 406 has a lug body portion 408 configured such that a portion or surface of the lug body portion 408 is exposed to the sleeve-receiving section 208 of the terminal recess 206. In this regard, the surface of the lug body portion 408 can have the same contour as the semi-cylindrical shape of the sleeve-receiving section 208, and the surface of the lug body portion 408 is configured be in direct physical contact with a terminal fitting 140 when placed within the sleeve-receiving section 208 of the first terminal block 200.

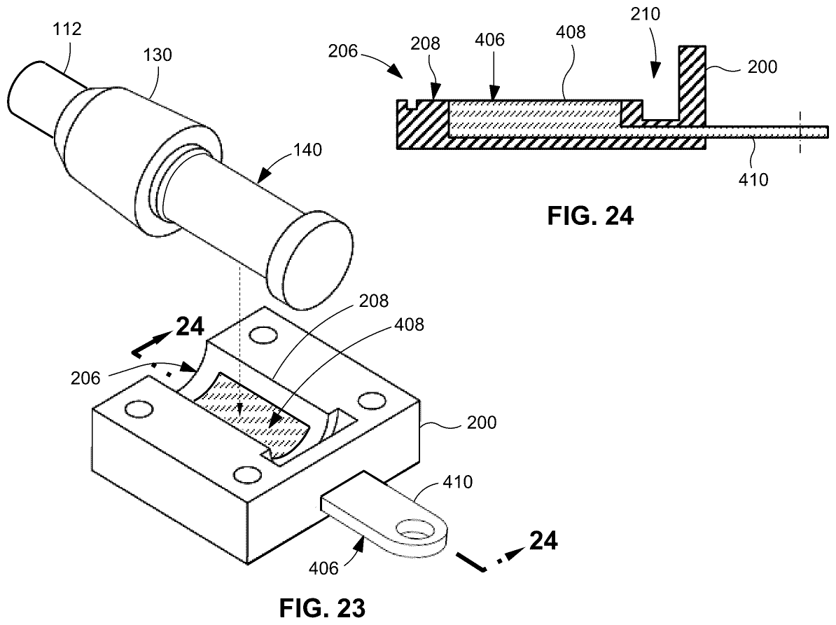

As shown in FIGS. 23-25, the lug fitting 406 has a lug tongue 410 that protrudes outwardly from the first terminal block 200. The lug tongue 410 is configured to be coupled to the external electrical component 450. In the example shown, the lug tongue 410 has a tongue hole for placing over a terminal stud 454 of a conventional terminal block 452 as shown in FIG. 25. The conventional terminal block 452 can be a power feeder panel (not shown), such as the power feeder panel of a commercial airliner (not shown). The lug tongue 410 is configured to be secured to the external electrical component 450 via a washer 308 and nut 306 as shown in FIG. 25. Advantageously, the lug fitting 406 provides a means for retrofitting the presently-disclosed terminal block module 102 to a conventional terminal block 452 (e.g., a power feeder panel).

The lug fitting 406 can be separately manufactured and molded into the first or second terminal block 200, 202. Alternatively, the lug fitting 406 can be inserted into and/or assembled with the first or second terminal block 200, 202. Although the example of the terminal block module 102 of FIGS. 22-25 is configured to contain a single terminal fitting 140, in other examples not shown, the terminal block module 102 can be configured to contain two or more terminal fittings 140, at least one of which is in direct physical contact with a lug fitting 406 that is at least partially embedded in the first or second terminal blocks 200, 202 as shown in FIG. 24. For example, only one of the terminal fittings 140 can be electrically coupled to the lug body portion 408 (e.g., FIG. 24), and all of the terminal fittings 140 can be electrically coupled to each other via an additional electrically conductive element 400 (i.e., not shown) in the form of an electrically conductive layer 402 (e.g., FIG. 8) or an electrically conductive plate 404 (e.g., FIG. 11). Alternatively for a terminal block module 102 containing two or more terminal fittings 140, the terminal block module 102 can contain a lug fitting 406 configured to be in direct physical contact with each of the terminal fittings 140 at the sleeve-receiving sections 208 of the first terminal block 200.

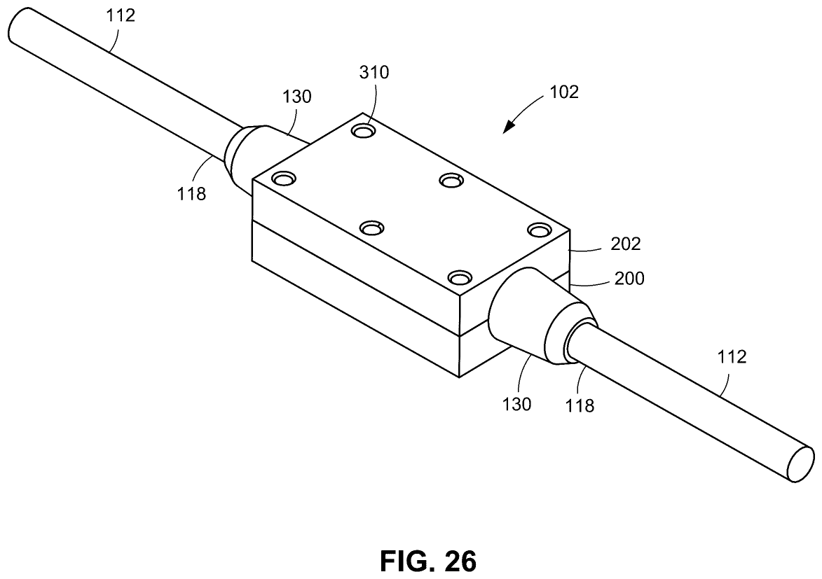

FIGS. 1-3, 8-9 11-14, 18, and 30-31 show examples of terminal block modules 102 wherein the first and second terminal blocks 200, 202 (i.e., when assembled) define two or more cavities 228 arranged in parallel and spaced apart side-by-side relation to each other. However, FIGS. 26-29 and 32-33 show alternative configurations of the terminal block modules 102 in which the first and second terminal blocks 200, 202 (i.e., when assembled) define two or more cavities 228 arranged in end-to-end relation to each other.

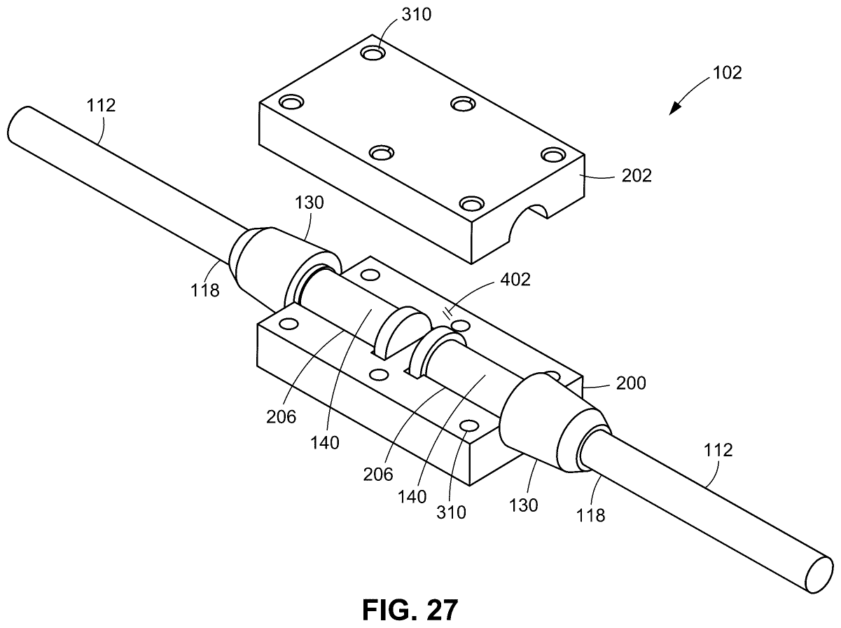

FIGS. 26-27 show an example of a terminal block module 102 configured to contain two terminal fittings 140 in end-to-end relation to each other. Each terminal fitting 140 is secured onto the cable end 118 of an electrical cable 112, and the terminal fittings 140 are received within the terminal recesses 206 in the first and second terminal blocks 200, 202. The first and second terminal blocks 200, 202 are secured to each other via mechanical fasteners 300 (not shown) installed in the fastener holes 310. Although not shown, the terminal block module 102 also includes an electrically conductive element 400 such as an electrically conductive layer 402 (e.g., FIG. 8). Alternatively or additionally, the terminal block module 102 includes an electrically conductive plate 404 (not shown) configured to extend at least partially into the two sleeve-receiving sections 208, similar to the arrangement shown in FIG. 11, except that the portion of the plate extending between the sleeve-receiving sections 208 would be oriented parallel to the lengthwise direction of the terminal fittings 140.

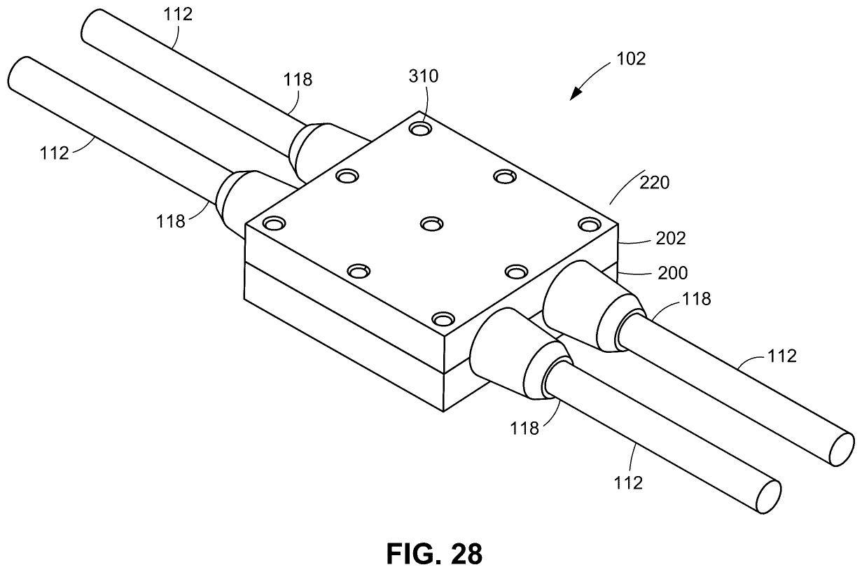

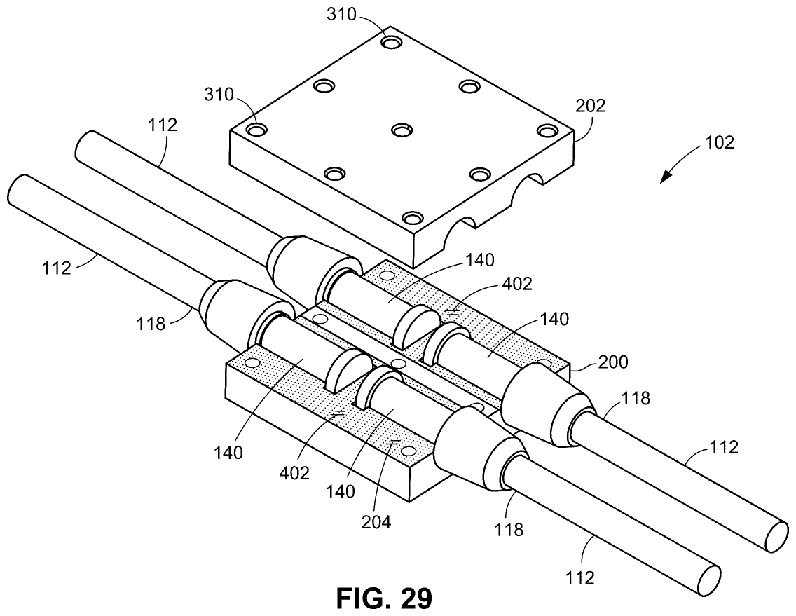

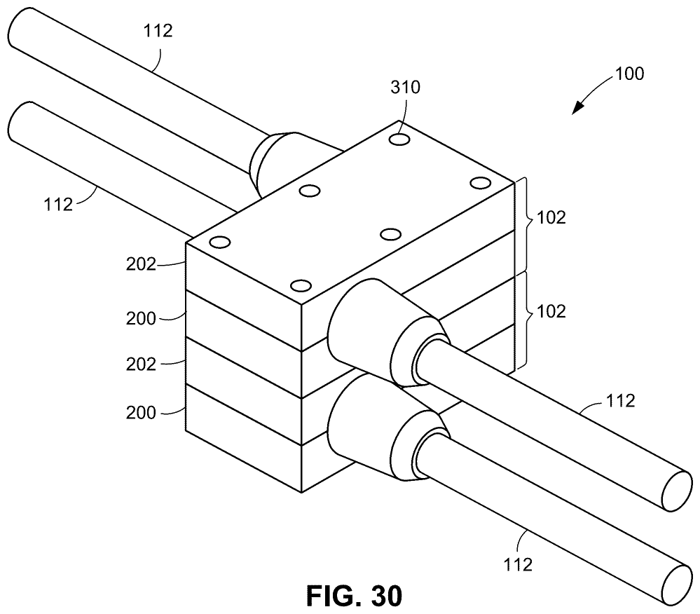

Referring to FIGS. 28-29, shown is an example of a terminal block module 102 configured to contain two pairs of terminal fittings 140, with each pair of terminal fittings 140 arranged in end-to-end relation to each other. Such an arrangement may accommodate two phases of electrical power. Although both pairs of terminal fittings 140 are contained within a single block assembly 220, each end-to-end pair of terminal fittings 140 is electrically separate from the other end-to-end pair of terminal fittings 140. In this regard, each end-to-end pair of terminal fittings 140 is electrically coupled via an electrically conductive layer 402 of material deposited onto the mating surface 204 of at least one of the first and second terminal blocks 200, 202. The electrically conductive layer 402 is omitted within a narrow strip of the mating surface 204 between the two end-to-end pairs of terminal fittings 140 as a means to electrically separate the pairs of end-to-end terminal fittings 140. Although FIGS. 28-29 show the terminal block module 102 containing only two pairs of terminal fittings 140, a terminal block module 102 can be provided with any number of end-to-end terminal fittings 140 not shown,

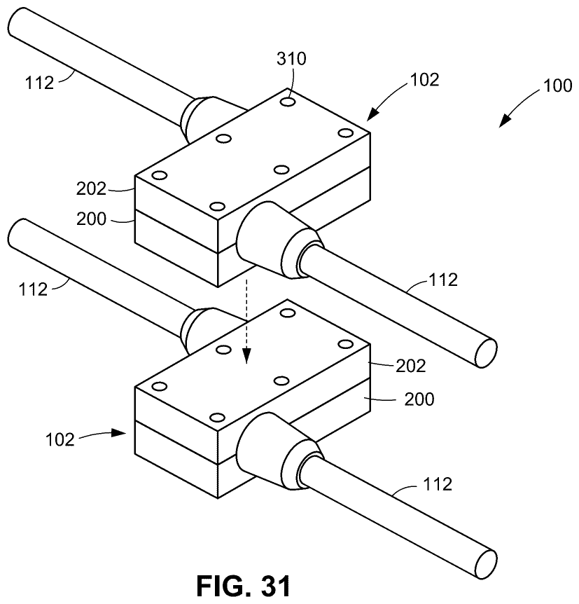

Referring to FIGS. 30-33, shown is a terminal block system 100 which includes two or more terminal block modules 102 positioned or located immediately adjacent to each other. Each terminal block module 102 in a terminal block system 100 can be configured to accommodate different phases of electrical power. In FIGS. 30-31, the terminal block system 100 includes two terminal block modules 102 stacked on top of each other. Each terminal block module 102 is configured similar to the above-described example shown in FIGS. 1-3 in which the terminal fittings 140 are arranged in side-by-side relation to each other. The terminal block modules 102 of FIGS. 30-31 are secured to each other using mechanical fasteners 300 (FIGS. 1-2) extending through the fastener holes 310 in the terminal block modules 102. Due to the non-electrically conductive material of the first and second terminal blocks 200, 202, the stacked terminal block modules 102 are electrically separate from each other. Although the example shown in FIGS. 30-31 includes two terminal block modules 102, a terminal block system 100 can include any number of terminal block modules 102 (e.g., three or more) stacked on top of each other and fastened together using mechanical fasteners 300.

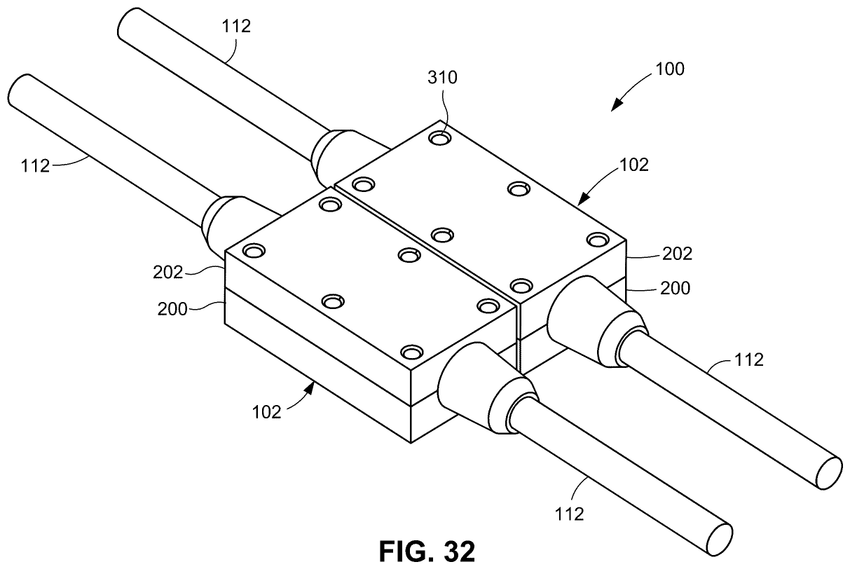

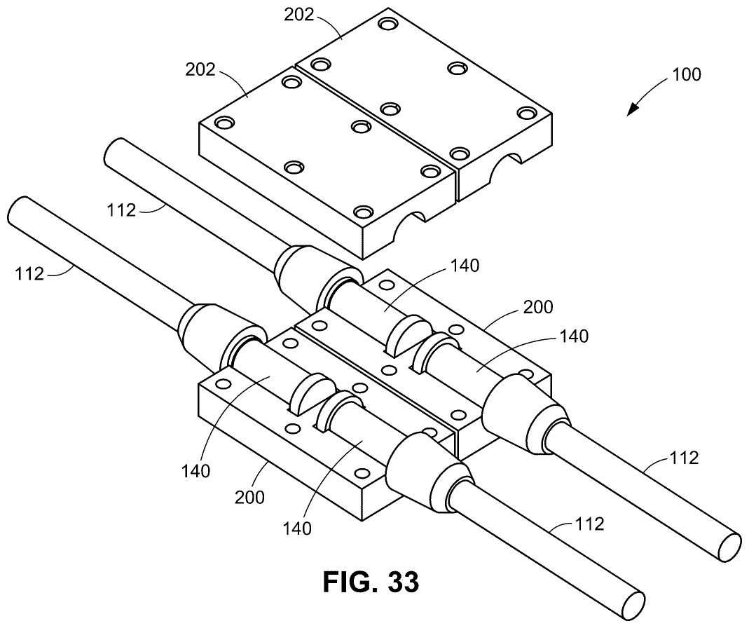

Referring to FIGS. 32-33, shown is an example of a terminal block system 100 having two terminal block modules 102 positioned side-by-side. In the example shown, the terminal block modules 102 are not directly fastened to each other and/or are not in contact with each other. However, in other examples not shown, a terminal block system 100 can include mounting tabs (not shown) for mechanically fastening the terminal block modules 102 to each other. Each terminal block module 102 in FIGS. 32-33 is configured similar to the above-described example shown in FIGS. 26-27 in which the terminal fittings 140 are arranged in end-to-end relation to each other. Although FIGS. 32-33 show two terminal block modules 102 positioned side by side, a terminal block system 100 can include any number of terminal block modules 102 (e.g., three or more) positioned side by side and fastened together using mechanical fasteners 300. In other examples not shown, a terminal block system 100 can include two or more terminal block modules 102 positioned side by side, and in which each terminal block is configured similar to the above-described example shown in FIGS. 1-3 in which the terminal fittings 140 are spaced apart and positioned side by side.

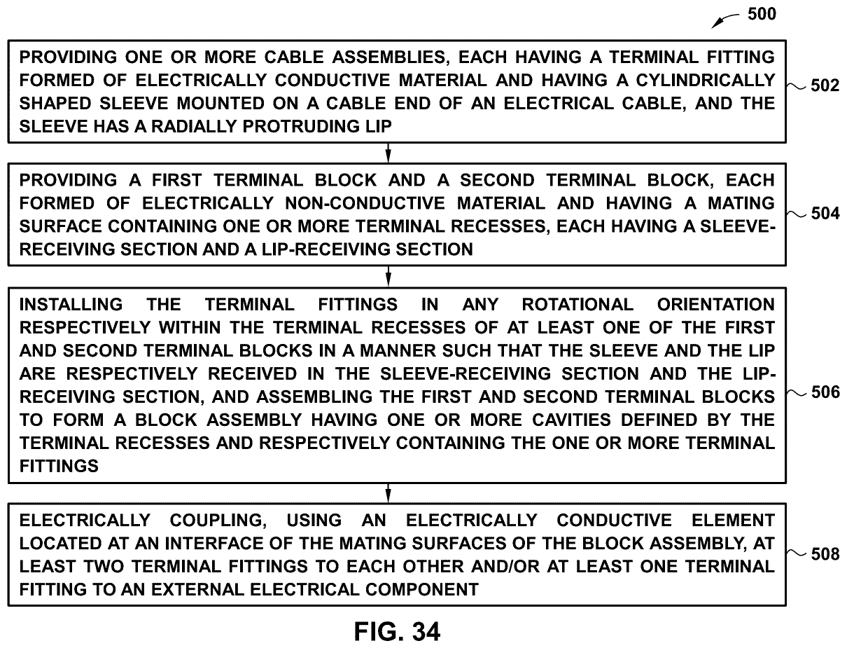

Referring to FIG. 34, shown is a flowchart of operations included in a method 500 of assembling a terminal block module 102. Step 502 of the method 500 comprises providing one or more cable assemblies 110, each having a terminal fitting 140 formed of electrically conductive material and having a cylindrically shaped sleeve 144 mounted on a cable end 118 of an electrical cable 112. In some examples, step 502 includes installing the sleeve 144 on the cable end 118 of the electrical cable 112 via crimping, swaging, soldering, or any one of a variety of other techniques for mechanically securing the terminal fitting 140 onto the cable end 118. As described above and shown in FIGS. 2-8, the sleeve 144 has a lip 156 radially protruding from the sleeve 144. In this regard, the lip 156 is wider (e.g., larger in diameter) than the sleeve 144.

Step 504 of the method 500 includes providing a first terminal block 200 and a second terminal block 202, each formed of electrically non-conductive material and having a mating surface 204 containing one or more terminal recesses 206, each having a sleeve-receiving section 208 and a lip-receiving section 210 configured complementary respectively to the sleeve 144 and the lip 156. As described above, the electrically non-conductive material of the first and second terminal blocks 200, 202 can be a plastic or polymeric material, composite material (e.g., carbon-fiber), ceramic material, and/or any one of a variety of other types of electrically non-conductive materials.

Step 504 of providing the first and second terminal blocks 200, 202 includes providing each of the first and second terminal blocks 200, 202 with at least two terminal recesses 206 arranged in parallel and spaced relation. FIGS. 2-3, 8, 11-13, and 18 show examples of terminal block modules 102 in which the terminal recesses 206 in each of the first and second terminal blocks 200, 202 are arranged in side-by-side relation to each other. FIGS. 26-29 and 32-33 show examples of terminal block modules 102 in which the terminal recesses 206 in each of the first and second terminal blocks 200, 202 are arranged in end-to-end relation to each other. However, in other terminal block module 102 configurations not shown, the first and second terminal blocks 200, 202 can contain terminal recesses 206 arranged in any one of a variety of alternative orientations relative to each other, and are not limited to a side-by-side arrangement or an end-to-end arrangement as shown in the figures.

Step 506 of the method 500 includes installing the one or more terminal fittings 140 of the one or more cable assemblies 110 in any rotational orientation respectively within the one or more terminal recesses 206 of at least one of the first and second terminal blocks 200, 202 in a manner such that the sleeve 144 and the lip 156 are respectively received in the sleeve-receiving section 208 and the lip-receiving section 210. Step 506 also includes assembling the first and second terminal blocks 200, 202 to form a block assembly 220 having one or more cavities 228 collectively defined by the terminal recesses 206 and respectively containing the one or more terminal fittings 140. As mentioned above, the cylindrical shape of the sleeve 144 of each terminal fitting 140 allows each terminal recess 206 to receive the terminal fitting 140 in any rotational orientation about its central axis 142. The lip 156 of each terminal fitting 140 is received within the lip-receiving section 210 of the terminal recess 206, which limits or prevents axial movement of the terminal fitting 140 within the cavity 228 collectively defined by the terminal recesses 206 when the first and second terminal blocks 200, 202 are assembled to each other.

The method 500 further includes fastening together the first and second terminal blocks 200, 202 of the block assembly 220 using one or more mechanical fasteners 300. The first and second terminal blocks 200, 202 can be assembled to each other after installation of the terminal fittings 140 (i.e., while attached to electrical cables 112) in the terminal recesses 206. As described above, the mechanical fasteners 300 can be provided as bolts 304 or screws extending through fastener holes 310 formed in each of the first and second terminal blocks 200, 202. Alternatively or additionally, the mechanical fasteners 300 can be provided as threaded studs (not shown) protruding from the mating surface 204 of the first and/or second terminal blocks 200, 202. Such threaded studs can be configured to extend through the fastener holes 310 formed in the remaining first or second terminal block 200, 202.

In some examples (e.g., FIGS. 14-17 and 22-23), the method 500 includes sealing each electrical cable 112 to the block assembly 220 using a cable seal 130 surrounding the electrical cable 112 at a cable exit 224 of the block assembly 220 in a manner limiting exposure of the interface 222 to an external environment 420 of the block assembly 220. In this regard, the cable seal 130 can prevent the intrusion of moisture, debris, and/or contaminants that can otherwise migrate to the terminal fitting 140. As mentioned above, the cable seal 130 is formed of elastomeric material such as silicon or rubber or other polymeric material. As shown in FIGS. 16-17 and described above, the cable seal 130 includes a reduced-diameter portion 132 that has an annular shoulder 134 configured to be received within an annular groove 226 formed in the block assembly 220 at the cable exit 224 to retain the cable seal 130 in position and reduce exposure of the interface 222 and terminal fittings 140 to the external environment 420.

Referring briefly to FIGS. 18-21, some examples of the method 500 include installing a block seal 230 along a perimeter of the interface 222 of the block assembly 220 in a manner limiting exposure of the interface 222 to the external environment 420 of the block assembly 220. As described above, the block seal 230 is preferably formed of an electrically non-conductive material that is positioned between the first and second terminal blocks 200, 202 when assembled to each other. The method 500 can include installing the block seal 230 as an elastomeric material placed on the mating surface 204 of the first or second terminal block 200, 202. As shown in FIGS. 19-20, the elastomeric seal 232 can optionally be installed in a perimeter groove 234 formed along the perimeter of the mating surface 204 of the first and/or second terminal blocks 200, 202. Alternatively or additionally, the method 500 can include installing the block seal 230 as a sealant bead 236 of wet sealant applied to the mating surface 204 of the first and/or second terminal blocks 200, 202 (e.g., FIG. 21) prior to assembly, after which the sealant bead 236 of wet sealant cures over time and prevents the intrusion of contaminants into the terminal block module (102).

Step 508 of the method 500 includes electrically coupling, using an electrically conductive element 400 located at an interface 222 of the mating surfaces 204 of the block assembly 220, at least two terminal fittings 140 to each other and/or at least one terminal fitting 140 to an external electrical component 450 that is separate from the block assembly 220. As described above, electrically coupling at least two terminal fittings 140 can be performed using an electrically conductive layer 402 of material deposited onto the mating surface 204 and the sleeve 144 receiving section of the terminal recesses 206 of at least one of the first and second terminal blocks 200, 202. As shown in FIGS. 8-13, 27, 29, and 33, the electrically conductive layer 402 extends at least partially into the sleeve-receiving section 208 of each terminal recess 206. Alternatively or additionally, electrically coupling at least two terminal fittings 140 can be performed by installing an electrically conductive plate 404 between the mating surfaces 204 of the first and the second terminal blocks as shown in FIGS. 11-13. As described above, the electrically conductive plate 404 is configured to maintain contact with the terminal fittings 140 when captured within the block assembly 220.

For the example shown in FIGS. 22-25 in which the electrically conductive element 400 is configured to electrically couple at least one terminal fitting 140 to an external electrical component 450, step 508 includes securing a lug tongue 410 of a lug fitting 406 to a terminal stud 454 of the external electrical component 450. As described above, the lug fitting 406 is at least partially contained within the first or second terminal block 200, 202 in a manner such that a lug body portion 408 of the lug fitting 406 is in direct physical contact with a terminal fitting 140 when installed in the terminal recess 206 of the first or second terminal block 200, 202, as shown in FIGS. 23-24. The lug tongue 410 protrudes from the first or second terminal block 200, 202, and has a tongue hole that is placed over the terminal stud 454 of a conventional terminal block 452 (e.g., of a power feeder panel) and secured via a washer 308 and nut 306. As described above, the lug fitting 406 can be molded into the first or second terminal blocks 200, 202, or the lug fitting 406 can be separately manufactured and assembled with the first or second terminal block 200, 202.

Referring to the examples of FIGS. 30-33, the method 500 can further include placing or positioning two or more terminal block modules 102 immediately adjacent to each other, as may be required for applications where the two or more terminal block modules 102 are required for respectively handling different phases of electrical power. In this regard, although the terminal block modules 102 of a terminal block system 100 can be physically contacting each other (e.g., FIG. 30), the terminal block modules 102 are electrically segregated. FIGS. 30-31 show an example of stacking the two or more terminal block modules 102 on top of each other. Although not shown, the terminal block modules 102 of FIGS. 30-31 are secured to each other using mechanical fasteners 300 extended through the fastener holes 310. FIGS. 32-33 shows an example of positioning the two or more terminal block modules 102 side by side. Although not shown, the terminal block modules 102 can be secured to each other using any one a variety mechanical features.

Any of the structural arrangements and/or functional capabilities of any of the terminal block modules 102 and/or associated components (e.g., terminal fittings 140, first and second terminal blocks 200, 202, electrically conductive elements 400, seals, etc.) described herein and shown in FIGS. 1-27 are applicable to any one of the terminal block modules 102 or terminal block systems 100 of FIGS. 28-33.

Advantageously, the various configurations of the terminal block module 102 and method 500 described above provide a simple and low-cost means for securing an electrical cable 112 in any orientation to a terminal block module 102 without introducing mechanical stress (i.e., preload) on the electrical cable 112 or on the first and second terminal blocks 200, 202. Furthermore, the cable seals 130 and/or block seals 230 optionally included with the terminal block module 102 provide a means for ensuring that the terminal fittings 140 are sealed from exposure to the external environment 420, thereby avoiding the potential for corrosion. In this regard, the presently-disclosed terminal block module 102 avoids time-consuming and costly rework and/or repair or replacement of electrical cables 112 attached to conventional terminal blocks 452.

Many modifications and other configurations of the disclosure will come to mind to one skilled in the art, to which this disclosure pertains, having the benefit of the teachings presented in the foregoing descriptions and the associated drawings. The configurations described herein are meant to be illustrative and are not intended to be limiting or exhaustive. Although specific terms are employed herein, they are used in a generic and descriptive sense only and not for purposes of limitation.

What is claimed is:

1. A terminal block module, comprising:
one or more terminal fittings, each formed of electrically conductive material and having a cylindrically shaped sleeve configured to receive a cable end of an electrical cable, and having a lip radially protruding from the sleeve;
a first terminal block and a second terminal block, each formed of electrically non-conductive material and having a mating surface containing one or more terminal recesses, each having a sleeve-receiving section and a lip-receiving section configured complementary respectively to the sleeve and the lip and collectively forming one or more cavities configured to respectively contain the one or more terminal fittings when the first and second terminal blocks are assembled to form a block assembly, and each cavity is configured to receive a terminal fitting in any rotational orientation, and prevent axial movement of the terminal fitting via the lip; and
an electrically conductive element locatable at an interface of the mating surfaces of the block assembly and configured to electrically couple at least two terminal fittings to each other and/or electrically couple at least one terminal fitting to an external electrical component that is separate from the block assembly.

2. The terminal block module of claim 1, wherein the electrically conductive element comprises at least one of the following:
an electrically conductive layer of material deposited onto the mating surface and the one or more sleeve-receiving sections of at least one of the first and second terminal blocks; and
an electrically conductive plate configured to be positioned between the mating surfaces of the first and the second terminal blocks in a manner maintaining contact with the one or more terminal fittings when contained within the block assembly.

3. The terminal block module of claim 1, further comprising:
a cable seal configured to surround at least one of the electrical cables at a cable exit from one of the cavities of the block assembly, and configured to limit exposure of the interface to an external environment of the block assembly.

4. The terminal block module of claim 1, further comprising:
a block seal positionable along a perimeter of the interface of the block assembly, and configured to limit exposure of the interface to an external environment of the block assembly.

5. The terminal block module of claim 1, further comprising:
one or more mechanical fasteners configured to fasten together the first and second terminal blocks of the block assembly.

6. The terminal block module of claim 1, wherein each of the first and second terminal blocks contains two or more cavities arranged in spaced relation to each other according to one of the following arrangements:
in side-by-side relation to each other;
in end-to-end relation to each other.

7. The terminal block module of claim 1, wherein:
the sleeve has a sleeve opening into which the cable end is insertable; and
the lip of at least one of the terminal fittings is located on an end of the sleeve opposite the sleeve opening.

8. The terminal block module of claim 1, wherein the electrically conductive element that is configured to electrically couple at least one terminal fitting to the external electrical component comprises:
a lug fitting configured to be at least partially contained within one of the first and second terminal blocks and having a lug body portion configured to physically contact at least one of the one or more terminal fittings when captured within a cavity of the block assembly, and the lug fitting has a lug tongue that protrudes outwardly from the one of the first and second terminal blocks and configured to be coupled to the external electrical component.

9. A terminal block system, comprising:
two or more terminal block modules immediately adjacent to each other and electrically non-connected, and each terminal block module includes:
one or more terminal fittings, each formed of electrically conductive material and having a cylindrically shaped sleeve configured to receive a cable end of an electrical cable, and having a lip radially protruding from the sleeve;
a first terminal block and a second terminal block, each formed of electrically non-conductive material and having a mating surface containing one or more terminal recesses, each having a sleeve-receiving section and a lip-receiving section configured complementary respectively to the sleeve and the lip and collectively forming one or more cavities configured to respectively contain the one or more terminal fittings when the first and second terminal blocks are assembled to form a block assembly, and each cavity is configured to receive a terminal fitting in any rotational orientation and prevent axial movement of the terminal fitting via the lip; and
an electrically conductive element locatable at an interface of the mating surfaces of the block assembly and configured to electrically couple at least two terminal fittings to each other and/or electrically couple at least one terminal fitting to an external electrical component that is separate from the block assembly.

10. The terminal block system of claim 9, wherein the two or more terminal block modules are positioned according to one of the following arrangements:
stacked on top of each other;
positioned side-by-side.

11. A method of assembling a terminal block module, comprising:
providing one or more cable assemblies, each having a terminal fitting formed of electrically conductive material and having a cylindrically shaped sleeve mounted on a cable end of an electrical cable, and having a lip radially protruding from the sleeve;
providing a first terminal block and a second terminal block, each formed of electrically non-conductive material and having a mating surface containing one or more terminal recesses, each having a sleeve-receiving section and a lip-receiving section configured complementary respectively to the sleeve and the lip;
installing the one or more terminal fittings of the one or more cable assemblies in any rotational orientation respectively within the one or more terminal recesses of at least one of the first and second terminal blocks in a manner such that the sleeve and the lip are respectively received in the sleeve-receiving section and the lip-receiving section, and assembling the first and second terminal blocks to form a block assembly having one or more cavities collectively formed by the terminal recesses and respectively containing the one or more terminal fittings, and each cavity prevents axial movement of the terminal fitting via the lip; and
electrically coupling, using an electrically conductive element located at an interface of the mating surfaces of the block assembly, at least two terminal fittings to each other and/or at least one terminal fitting to an external electrical component that is separate from the block assembly.

12. The method of claim 11, wherein the step of electrically coupling using the electrically conductive element comprises:
electrically coupling at least two terminal fittings to each other via at least one of the following:
an electrically conductive layer of material deposited onto the mating surface and the sleeve receiving section of the one or more terminal recesses of at least one of the first and second terminal blocks and extending at least partially into the sleeve-receiving section of the one or more cavities of each of the first and second terminal blocks; and
an electrically conductive plate positioned between the mating surfaces of the first and the second terminal blocks and in contact with the one or more terminal fittings captured within the block assembly.

13. The method of claim 11, wherein the step of providing the one or more cable assemblies comprises:
installing the sleeve on the cable end of at least one electrical cable via at least one of crimping, swaging, and soldering.

14. The method of claim 11, further comprising:
sealing the electrical cable to the block assembly using a cable seal surrounding the electrical cable at a cable exit of the block assembly in a manner limiting exposure of the interface to an external environment of the block assembly.

15. The method of claim 11, further comprising:
installing a block seal along a perimeter of the interface of the block assembly in a manner limiting exposure of the interface to an external environment of the block assembly.

16. The method of claim 11, further comprising:
fastening together the first and second terminal blocks of the block assembly using one or more mechanical fasteners.

17. The method of claim 11, wherein the step of providing the first and second terminal blocks includes:
providing each of the first and second terminal blocks with at least two terminal recesses arranged in parallel and spaced relation to each other according to one of the following arrangements:
side-by-side relation to each other;
end-to-end relation to each other.

18. The method of claim 11, wherein the step of electrically coupling using the electrically conductive element comprises:
electrically coupling at least one terminal fitting to the external electrical component by securing to a lug tongue protruding from the terminal block to a terminal stud of the external electrical component, and the lug tongue is an extension of a lug fitting contained within one of the first and second terminal blocks and physically contacting the at least one terminal fitting.

19. The method of claim 11, further comprising:
positioning two or more of the terminal block modules immediately adjacent to each other.

20. The method of claim 19, wherein positioning the two or more of the terminal block modules immediately adjacent to each other comprises at least one of the following:
stacking the two or more terminal block modules on top of each other; and
positioning the two or more terminal block modules side-by-side.
